(19) United States
(12) Patent Application Publication
(10) Pub. No.: US 2023/0064621 A1
(43) Pub. Date: Mar. 2, 2023

(54) TRACKING SYSTEM FOR DETERMINING RELATIVE MOVEMENTS BETWEEN TWO VEHICLE PARTS

(71) Applicant: HÜBNER GmbH & Co. KG, Kassel (DE)

(72) Inventors: Marcus Riehn, Osterode (DE); Sebastian Harz, Söhrewald (DE); Heiko IIIig, Schauenburg (DE); Frederik Franz, Kassel (DE); Maximillan Moritzen, Kassel (DE)

(21) Appl. No.: 17/891,602

(22) Filed: Aug. 19, 2022

(30) Foreign Application Priority Data
Sep. 2, 2021 (EP) 21194513.4

(51) Int. Cl. B62D 47/02; B60W 40/10; B60W 30/04

(52) U.S. Cl. CPC B62D 47/025; B60W 40/10; B60W 30/04; B60W 2300/10

(57) ABSTRACT

A tracking system has a first tracking module and a second tracking module, the position and/or orientation of which relative to each other can be determined by means of a sensor device of the tracking system to determine relative movements of a first vehicle part of a set of vehicles relative to a second vehicle part of the set of vehicles that is movably connected to the first vehicle part. The first tracking module is connected to the first vehicle part and the second tracking module is connected to the second vehicle part.

### CROSS-REFERENCE TO RELATED APPLICATIONS

This application claims priority to European application number 21194513.4 filed Sep. 2, 2021, the disclosure of which is hereby incorporated by reference in its entirety.

### FIELD OF THE INVENTION

The invention concerns the use of a tracking system comprising two tracking modules for determining relative movements between two movably connected vehicle parts of a set of vehicles. Moreover, the invention concerns a method for determining relative movements between two movably connected vehicle parts of a set of vehicles, and a set of vehicles with two movably connected vehicle parts.

### BACKGROUND OF THE INVENTION

In particular in public transport, vehicles are used that have multiple vehicle parts, in order to be able to transport as many passengers as possible. Such a set of vehicles is composed of multiple vehicle parts that are movably connected, so that the set of vehicles is sufficiently maneuverable and flexible. Such a set of vehicles may be a rail vehicle, e.g., a standard-gage railroad, a metro, a tram, or a bus having two or more movably connected vehicle parts. Usually, the flexible connection is achieved by using an articulated connection or a coupling between the vehicle parts.

Operation of, e.g., an articulated bus that has two articulately connected vehicle parts may require to continuously determine the so-called buckling angle, i.e., the angle between the two longitudinal axes of the vehicle parts. Specifically, a joint that connects the two vehicle parts can be controlled in dependence on the current buckling angle, e.g., to adjust a joint damper in dependence on demand.

It is also known that sensors are used in rail vehicles to determine the angle between the longitudinal axes of the vehicle parts. Such a system is described, e.g., in the document DE 10 2012 202 838 A1.

### SUMMARY OF THE INVENTION

The task of the invention is to propose an alternative, and in particular optimized, system that allows the determination of relative movements between vehicle parts of a set of vehicles during operation.

The task according to the invention is solved by using a tracking system having the features of the independent claim 1. Furthermore, the task according to the invention is solved by a method having the features of the independent claim 11, and by a set of vehicles having the features of the independent claim 15.

During operation, there are up to six degrees of freedom of movement between two movably connected vehicle parts of a set of vehicles, and to completely describe the relative movements of the two vehicle parts, the movements in relation to all these six degrees of freedom of movement need to be known. According to the invention, it was realized that tracking systems like those known from other technical areas, e.g., for determining the position and/or orientation of objects or persons, can also be used for vehicles to determine relative movements between movably connected vehicle parts of a set of vehicles. Therefore, according to the invention, an actually known tracking system is used that has a first tracking module and a second tracking module the position and/or orientation of which relative to each other can be determined by means of a sensor device of the tracking system. In particular, the sensor device is designed in such a way that the position of the two tracking modules in space relative to each other can be determined in relation to all degrees of freedom of movement of the two vehicle parts.

According to the invention, the first tracking module is connected to the first vehicle part and the second tracking module is connected to the second vehicle part. The tracking modules can be connected to the associated vehicle part either directly or indirectly. For example, the tracking modules can be located in the floor or the ceiling area of the respective vehicle part. If the tracking system is to be used also during operation, the tracking modules and the sensor device are preferably installed in a location that is not accessible, or at least invisible, to the passengers.

When the first tracking module is connected to the first vehicle part and the second tracking module is connected to the second vehicle part, the position and/or orientation of the tracking modules relative to each other can be used to infer the position and/or orientation of the two vehicle parts relative to each other. This, in turn, allows inference of the relative movements that occur between the two vehicle parts. Ultimately, therefore, such a tracking system can be used to determine the relative movements between the two vehicle parts that occur during operation.

Various possibilities exist to determine the position and/or orientation between the two tracking modules. For example, one or multiple distance and/or angle data between the two tracking modules can be used for this purpose. Also, the position and/or orientation can be determined by means of a pattern which is located on one of the tracking modules and of which a picture is taken by the sensor device located on the other tracking module. For example, a change of the position and/or orientation can be represented as a distortion and/or change of size in the picture.

In case of a given number of possible degrees of freedom of movement for the relative movements of the two vehicle parts, a number of independent measured variables that corresponds to that given number is sufficient to completely describe the orientation and position of the two tracking modules, and hence of the two vehicle parts. Accordingly, six independent measured variables are required in the case of the six possible degrees of freedom that usually exist in the case of two interconnected rail vehicle parts. The sensor device is set up in such a way that it can capture the measured variables as required for a specific application. The measurement can be an optical measurement. However, various other possibilities exist.

According to an embodiment of the invention, the sensor device has at least one draw-wire linear transducer that measures distance data between the tracking modules. The distance data can be an absolute distance and/or a change of distance. Specifically, the draw-wire linear transducer is connected at the first tracking module at a first linkage point and at the second tracking module at a second linkage point. In this way, e.g., a change of distance between the two linkage points can be determined by means of the draw-wire linear transducer. The change of distance in particular relates to a previously known distance of the two tracking modules relative to each other that exists when the two vehicle parts, and hence also the two tracking modules, are in a predefined reference position in relation to each other. The current absolute distance can be inferred from the previously known distance and the change of distance.

If relative movements with more degrees of freedom of movement are to be recorded, additional independent measured variables need to be determined by means of the sensor device. According to an embodiment of the invention, the sensor device, to this end, has a total of six draw-wire linear transducers, the draw-wire linear transducers being used to determine six distances or changes of distance that are independent of each other, so that all in all a relative movement of the two tracking modules with six degrees of freedom can be determined. The tracking modules and the draw-wire linear transducers can be arranged similar to a hexapod. This means, three linkage points are provided at the first tracking module and three linkage points at the second tracking module, with two draw-wire linear transducers at each linkage point at the first or second tracking module extending in the direction of the respective other tracking module, but, there, being connected to different linkage points, so that changes of distance that are independent of each other are determined.

The use of draw-wire linear transducers is one possibility to determine the position and/or orientation of the tracking modules relative to each other, and to infer the relative movements of the vehicle parts in this way. Another possibility is that the sensor device has at least one optical sensor that can be used to determine a change of the position and/or orientation between the two tracking modules. To this end, the optical sensor can be arranged at the first tracking module, with a reference object being arranged at the second tracking module and the optical sensor being used, e.g., to determine the distance to the reference object.

The optical sensor can in particular be a camera that records a picture of the reference object. The picture of the reference object can be used to infer the position and/or orientation of the two tracking modules relative to each other. For example, a position of the reference object in the picture can be determined for this purpose. A comparison with a previously recorded reference picture allows to determine how the position and/or orientation has changed. Also, given measured variables, such as the distance between two reference objects that are arranged at a distance to one another, or the geometrical dimensions of a reference object, can be evaluated when the image is evaluated, so as to infer changes of the position and/or orientation of the two tracking modules relative to each other.

Other optical sensors can also be used instead of a camera-based sensor. For example, a laser-based sensor can be used to measure a distance between the sensor and the reference object.

The reference object can be a predefined mark on the second tracking module or a significant geometry at the second tracking module. In particular, the reference object can be a self-luminous or reflective marker that ensures that even under unfavorable lighting conditions the reference object can be reliably detected, and hence a change of the position and/or orientation can be reliably determined. In particular, multiple reference objects in the form of markers can be arranged at one of the two tracking modules. For example, a reference object can be designed as a kind of coordinate system, with a marker arranged at each end of the coordinate system. In an evaluation of the image, the positions of the markers and, ultimately, the distances between the markers can be determined, which in turn allows inference of the position and/or orientation of the two tracking modules relative to each other.

According to an embodiment of the invention, two optical sensors are arranged at a distance to one another at one of the two tracking modules, while one or multiple reference objects are located at the other tracking module. The two optical sensors, e.g., take pictures of the reference objects. To evaluate whether and how the position and/or orientation of the two tracking modules relative to each other has changed, a reference picture is taken first at a reference position of the two vehicle parts, and hence also of the two tracking modules relative to each other. After that, the two optical sensors at the one tracking module take pictures of the reference objects at the other tracking module continuously or at predefined intervals. Changes of the position and/or orientation of the two tracking modules relative to each other can be inferred by comparing each current picture with a reference picture. Also, consecutively recorded pictures can be compared with each other to obtain information about the dynamics of the changes of position and/or orientation that occur.

According to an embodiment of the invention, the sensor device can be designed in such a way that the following measured variables can be determined by means of the sensor device: an acceleration, an angular rate and/or a magnetic field, or a change of the relevant measured variables. In this process, the relevant measured variables are in particular determined in all three spatial directions. To determine the abovementioned measured variables, the sensor device can have one or more than one of the following sensors: an acceleration sensor, an angular rate sensor and/or a magnetic field sensor. Preferably, each tracking module can have an appropriate group of sensors which are combined into a unit, in particular in the form of a sensor module. Specifically, IMUs (Inertial Measurement Units) or MARG sensors (Magnetic, Angular Rate, Gravity) are mentioned. Each tracking module can also have several such sensor modules. The use of such sensor modules allows implementation of the tracking system at especially low cost and/or with especially low installation space requirements. Accordingly, such a tracking system can be installed as standard equipment in a set of vehicles without high expenditure and/or without considerable restrictions, so that the relative movements between the vehicle parts of the set of vehicles can be determined at all times during operation of the set of vehicles.

If, for example, all of the abovementioned measured variables are to be determined in all three spatial directions for each tracking module, a total of nine measured values is obtained which are acquired simultaneously or at least nearly simultaneously for each tracking module. Preferably, the relevant measured values for the two tracking modules are recorded synchronously or largely synchronously. The position and/or orientation of the respective tracking module can be inferred from the measured values acquired for the different measured variables. Ultimately, a relative movement between the two interconnected vehicle parts can be identified by comparing the position and/or orientation of the respective tracking modules. In particular, the measured values of the individual sensors are combined according to the sensor fusion principle in such a way that the drawbacks, such as sensor drift and sensor noise, with respect to the individual measured variables are offset. Algorithms that can be used to achieve this include the following: Kalman filter, extended Kalman filter, complementary filter, and Madgwick filter.

To improve the accuracy of the measurement, the sensor device can have at least one GNSS sensor. In particular, such a GNSS sensor can be provided for each tracking module. For example, the GNSS sensor can also be used to synchronously record the respective measured variables of the tracking modules using the time data of the GNSS signal. Alternatively, or in addition, an external reference signal can also be used for this. This may be, e.g., a voltage pulse that is recorded by all tracking modules. The voltage pulse is generated periodically and transmitted by wire or wirelessly.

To be able to guarantee the reliability of the acquired measured values also over a longer period of time, it may be necessary to calibrate the sensor device or the sensors in a zero-position relative to each other at regular or irregular intervals. To this end, a calibration unit for automatic calibration of the acceleration sensor, the angular rate sensor and/or the magnetic field sensor can be provided in a further embodiment. The calibration unit has an input interface for receiving the data of the GNSS sensor and/or of an external reference signal, the acceleration sensor, the angular rate sensor and/or the magnetic field sensor being calibrated on the basis of the data of the GNSS sensor and/or the external reference signal. The source of the external reference signal can be, e.g., a mechanical, a magnetic or an optical switch. To this end, such a mechanical switch can, e.g., be designed in such a way that it is closed in the zero position and a reference signal is sent to the calibration unit. The signal can be transmitted by wire or wirelessly.

The individual sensors can be designed in such a way that the data is communicated and/or evaluated by appropriate means for data communication and/or evaluation of the set of vehicles. However, the sensors can also have their own data communication and/or evaluation, so that the sensor device can be operated separately from the set of vehicles. The information about position and/or orientation of the two tracking modules relative to each other can be used to infer what relative movements occur between the two vehicle parts in operation. In particular, the relative movements that occur can include one or more than one of the following movements: Buckling or swiveling movements, i.e. rotary movements around a vertical axis between the two vehicle parts; rolling movements, i.e. rotary movements around a vehicle longitudinal axis; pitching movements, i.e. rotary movements around a horizontal axis extending transverse to the vehicle longitudinal axis; transverse offset movements, i.e. translational movements in the direction of the horizontal axis extending transverse to the vehicle longitudinal axis; height offset movements, i.e. translational movements in the direction of the vertical axis between the two vehicle parts; bumping movements, i.e. translational movements in the direction of the vehicle longitudinal axis.

The relative movements can be indicated in relation to different reference points. For example, the measured variables determined by means of the tracking system can be evaluated in such a way that ultimately a relative movement between a front wall of a vehicle part in relation to an opposite front wall of the other vehicle part is indicated. The movement of the front walls can also be indicated in relation to a coupling and/or hinge point located in the area of a coupling or an articulated joint that connects the vehicle parts. This is readily possible especially if it is known where the respective tracking modules are located in a reference position in relation to the desired reference point, e.g., in relation to the front walls of the vehicle parts.

According to an embodiment of the invention of the invention, an evaluation device is provided that can be used to classify the relative movements determined. The classification is made in accordance with predefined standard movements which in particular can be the abovementioned relative movements, such as buckling, rolling, pitching, transverse offset, height offset and bumping movements. For example, the movement portions of which a determined relative movement is composed can be evaluated and a classification is made. Based on such classification, it can, e.g., be inferred to what extent a gangway system arranged between the vehicle parts is subjected to stresses with respect to the different standard movements. For example, it can be evaluated how frequently and to what extent each standard movement occurs. One can, e.g., examine the frequency and magnitude of buckling movements. In addition to this, one can examine what other movements occur simultaneously with a buckling movement. This information can be used, e.g., to derive test scenarios for a gangway system. Also, the point in time at which maintenance of the gangway system in operation will be necessary can be estimated on this basis. In particular in the case of continuous determination of the relative movement during operation, this allows predictive and demand-based planning of maintenance work.

The relative movements occurring between the vehicle parts in particular depend on a route profile that the set of vehicles is traveling. Accordingly, the route profile can also be inferred from the relative movements that occur. To this end, an appropriate evaluation device can be provided that can be used to acquire data about a course of a route profile on the basis of the relative movements determined. In addition to this, a GPS or GNSS sensor or a similar device can be provided to simultaneously map the course of the route. In particular, peculiarities of the route profile, such as types and characteristics of bends, can be inferred on the basis of the relative movements that occur. It can also be possible to infer the condition of a route profile. For example, a height offset that occurs abruptly can be indicative of an unevenness in the route profile that may be identifiable as such only insufficiently by a GPS or GNSS sensor.

In addition to this, the relative movements that occur may also be influenced by vehicle properties, in particular as regards their dynamics. Accordingly, an evaluation device provided according to the invention can also be used to infer a condition of a set of vehicles on the basis of the relative movements determined.

Furthermore, the invention concerns a method for determining relative movements of a first vehicle part of a set of vehicles relative to a second vehicle part of the set of vehicles that is movably connected to the first vehicle part. According to the invention, the relative movements are determined by means of a tracking system. For this purpose, a first tracking module of the tracking system is arranged at the first vehicle part and a second tracking module of the tracking system is arranged at the second vehicle part. Using a sensor device of the tracking system, a position and/or orientation of the two tracking modules relative to each other is determined, preferably continuously or quasi-continuously. The relative movements that occur can be inferred on this basis.

In particular, the method according to the invention can provide that a position and/or orientation of the two tracking modules at a predefined reference position of the two vehicle parts relative to each other is determined in the course of a calibration process. The current position and/or orientation of the two vehicle parts relative to each other in relation to the reference position can then be inferred from the previously known position and/or orientation at the reference position.

To determine the position and/or orientation of the two tracking modules relative to each other, e.g., at least one distance data between a first linkage point at the first tracking module and a second linkage point at the second tracking module can be acquired by means of a draw-wire linear transducer. In particular, distance data between different linkage points at the first tracking module and the second tracking module can be determined, for which purpose additional draw-wire linear transducers may be provided. The number of measured variables that are independent of each other in particular depends on the number of degrees of freedom of movement between the two vehicle parts required to completely describe their relative positions and hence the relative movements occurring between the vehicle parts.

Alternatively, or in addition, a picture, or pictures, can be taken of at least one reference object, arranged at the first or the second tracking module, by means of at least one optical sensor, and preferably by means of at least two optical sensors, arranged at the respective other tracking module. The picture or pictures taken can be used to determine a position and/or orientation of the two tracking modules relative to each other. Based on this, a relative movement between the two vehicle parts can be determined.

In the method according to the invention, the relative movements determined can be further evaluated. For example, the relative movements can be classified in accordance with predefined standard movements. Possible standard movements in particular include one or more than one of the following relative movements: Buckling or swiveling movements, rolling movements, pitching movements, transverse offset movements, height offset movements and bumping movements. A further possibility is to acquire data about a route profile that the set of vehicles is traveling, based on the relative movements determined.

The statements regarding the use according to the invention of the tracking system apply mutatis mutandis with respect to further embodiments of the method according to the invention.

The invention further relates to a set of vehicles having a first vehicle part and a second vehicle part, the two vehicle parts being movably connected. The set of vehicles is equipped with a tracking system that enables determination of relative movements of the first vehicle part in relation to the second vehicle part. The tracking system has a first tracking module which is (directly or indirectly) connected to the first vehicle part and a second tracking module which is (directly or indirectly) connected to the second vehicle part, and a sensor device that allows determination of a position and/or orientation of the two tracking modules relative to each other.

The statements regarding the use according to the invention of the tracking system and regarding the method according to the invention apply mutatis mutandis with respect to further embodiments of the set of vehicles according to the invention.

Further beneficial embodiments of the invention will be apparent from the claims, the description, and the drawings. The advantages of features and of combinations of several features mentioned in the description are merely exemplary and can take effect alternatively or cumulatively without the advantages necessarily having to be achieved by embodiments according to the invention. The features mentioned in the claims and the description are to be understood with respect to their number in such a way that exactly this number or a larger number than the number mentioned is present, without requiring an explicit use of the term “at least”. For example, when a sensor device is mentioned, this is to be understood as meaning that exactly one sensor device, two sensor devices or several sensor devices are present. These features may be supplemented by other features or may be the only features of which the respective product consists. The reference signs contained in the claims do not constitute a limitation of the scope of the objects protected by the claims. They serve only the purpose of making the claims easier to understand.

### BRIEF DESCRIPTION OF THE DRAWINGS

Further measures improving the invention are shown in more detail below with reference to the figures, together with a description of preferred embodiments of the invention.

FIG. 1 is a perspective view of a gangway between two vehicle parts, with a tracking system in accordance with a first embodiment;

FIG. 2 is a detail view of the tracking system in accordance with FIG. 1;

FIG. 3 is a perspective view of a gangway between two vehicle parts, with a tracking system in accordance with a second embodiment; and

FIG. 4 is a schematic representation of a graphic model for determining the position and/or orientation of two vehicle parts by means of a tracking system.

### DETAILED DESCRIPTION OF THE INVENTION

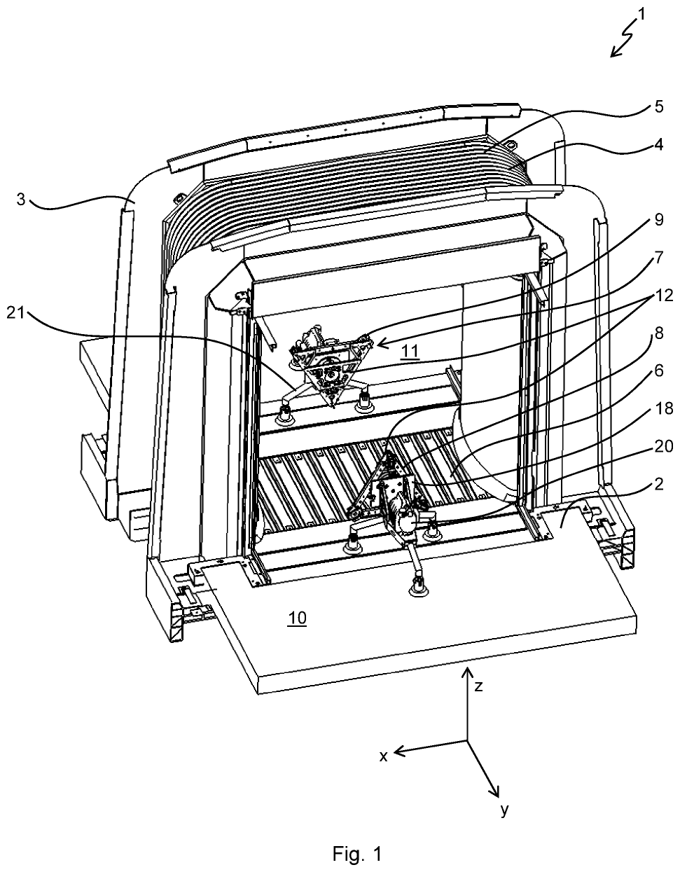

FIG. 1 is a schematic diagram of a gangway 1 between a first vehicle part 2 and a second vehicle part 3 that are movably connected. The embodiment shown is a set of vehicles in the form of a rail vehicle in which the vehicle parts 2 and 3 are connected, e.g., by a coupling. FIG. 1 only shows the end sections of the vehicle parts 2 and 3 that face each other. A gangway system 4 with a bellows 5 and a gangway platform 6 arranged in the floor area is arranged between the two vehicle parts 2 and 3 to protect passengers when walking from vehicle part 2 into vehicle part 3, or vice versa.

The vehicle parts 2 and 3 are connected to one another in such a way that various relative movements between the vehicle parts 2 and 3 are possible. These movements include, in particular, one or more than one of the following relative movements, depending on the type of the flexible connection: (i) buckling or swiveling movements, i.e., rotary movements around a vertical axis between the vehicle parts 2, 3, that runs in parallel with the axis referred to as z in FIG. 1; (ii) rolling movements, i.e., rotary movements around a horizontal axis between the vehicle parts 2, 3, that runs in parallel with the vehicle longitudinal axis referred to as y in FIG. 1; (iii) pitching movements, i.e., rotary movements around a horizontal axis between the vehicle parts 2, 3, that runs in parallel with the axis referred to as x in FIG. 1 that extends transverse to the vehicle longitudinal axis; (iv) transverse offset movements, i.e., translational movements in the direction of a horizontal axis between the vehicle parts 2, 3, that runs in parallel with the axis referred to as x in FIG. 1 that extends transverse to the vehicle longitudinal axis; (v) height offset movements, i.e., translational movements in the direction of a vertical axis between the vehicle parts 2, 3, that runs in parallel with the axis referred to as z in FIG. 1; and (vi) bumping movements, i.e., translational movements in the direction of a horizontal axis between the vehicle parts 2, 3, that runs in parallel with the vehicle longitudinal axis referred to as y in FIG. 1.

Specifically, all of the abovementioned relative movements can occur if the vehicle parts 2, 3, are connected by means of a coupling, whereas, e.g., primarily only buckling/swiveling movements, rolling movements and pitching movements are possible in case of an articulated connection.

For various purposes, it can be helpful to be able to determine the relative movements that actually occur or are to be expected during operation. For example, information about type and magnitude of the relative movements that occur can be important to enable appropriate dimensioning of the connection between the vehicle parts 2, 3, and/or the gangway system 4, in particular its bellows 5. Alternatively, or in addition, this information can be used to draw conclusions about upcoming maintenance work at the gangway 2 and/or about the route profile that the set of vehicles is traveling.

Therefore, according to the invention, a tracking system 7 is provided in the transition area between the two vehicle parts 2, 3, that enables determination of the relative movements between the two vehicle parts 2, 3.

In the embodiment shown in FIG. 1, the tracking system 7 comprises two tracking modules 8, 9, arranged opposite each other. The first tracking module 8 is fixedly arranged approximately at the center of the floor 10 of the first vehicle part 2. The second tracking module 9 is fixedly arranged approximately at the center of the floor 11 of the second vehicle part 3. In the embodiment shown in FIG. 1, arrangement in the floor area is preferred due to the weight of the tracking modules 8, 9.

Different from what is shown in FIG. 1, the tracking modules 8, 9, can in principle also be arranged, e.g., at the side walls or in the ceiling area of the respective vehicle part 2, 3. What is important is only that the position of the tracking module 8, 9, relative to the respective vehicle part 2, 3, is known. To this end, the tracking module 8, 9, is preferably arranged immovably relative to the vehicle part 2, 3. However, the position of the tracking module 8, 9, relative to the respective vehicle part 2, 3, may in principle also change during operation, in which case, however, the current relative position should be known.

The tracking system 7 comprises a sensor device 12 that can be used to determine the position and/or orientation of the two tracking modules 8, 9, relative to each other. Based on the position and/or orientation determined in this way, the position and/or orientation of the two vehicle parts 2, 3, and hence also the relative movements that occur between the vehicle parts 2, 3, can ultimately be inferred. In particular, the position and/or orientation of the two tracking modules 8, 9, relative to each other is determined continuously or quasi-continuously.

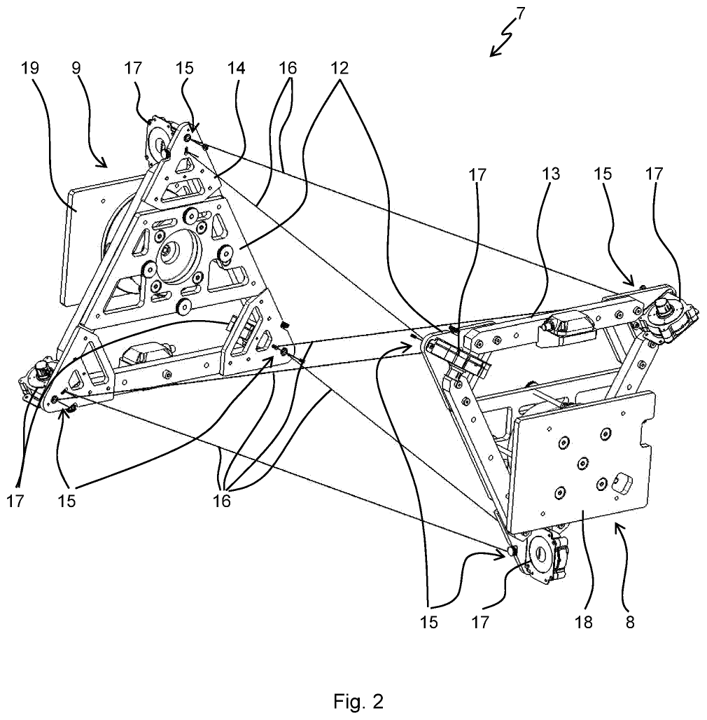

FIG. 2 shows the tracking system 7 in accordance with FIG. 1 and, in particular, its sensor device 12 in detail. The sensor device 12 comprises two triangular base bodies 13, 14, a base body 13 being assigned to the first tracking module 8 and a base body 14 being assigned to the second tracking module 9. Linkage points 15 for wires 16 of a total of six draw-wire linear transducers 17 are provided in the corner areas of the base bodies 13, 14. Two wires 16 that are linked at, or run through, two different linkage points 15 at the respectively opposite base body 13, 14, run through each linkage point 15.

When the tracking modules 8, 9, move in relation to each other, the distances between the linkage points 15 change and the changes of distance can be determined by means of the six draw-wire linear transducers 17. The six draw-wire linear transducers 17 determine a total of six measured variables that are independent of each other, so that the six possible degrees of freedom of movement (three rotational degrees of freedom and three translational degrees of freedom) can be determined. If there are less degrees of freedom of movement between the two vehicle parts 2, 3, of a set of vehicles, it may suffice to use a sensor device 12 with less measured variables that are independent of each other.

Each base body 13, 14, can be fastened to a fastening mount 20, 21, of the respective tracking module 8, 9, by means of a mounting adapter 18, 19. The provision of the mounting adapters 18, 19, makes is especially simple to mount the tracking system 7. Also, this allows easy fine adjustment of the position of the tracking modules 8, 9, and, in particular, of the base bodies 13, 14, in relation to each other.

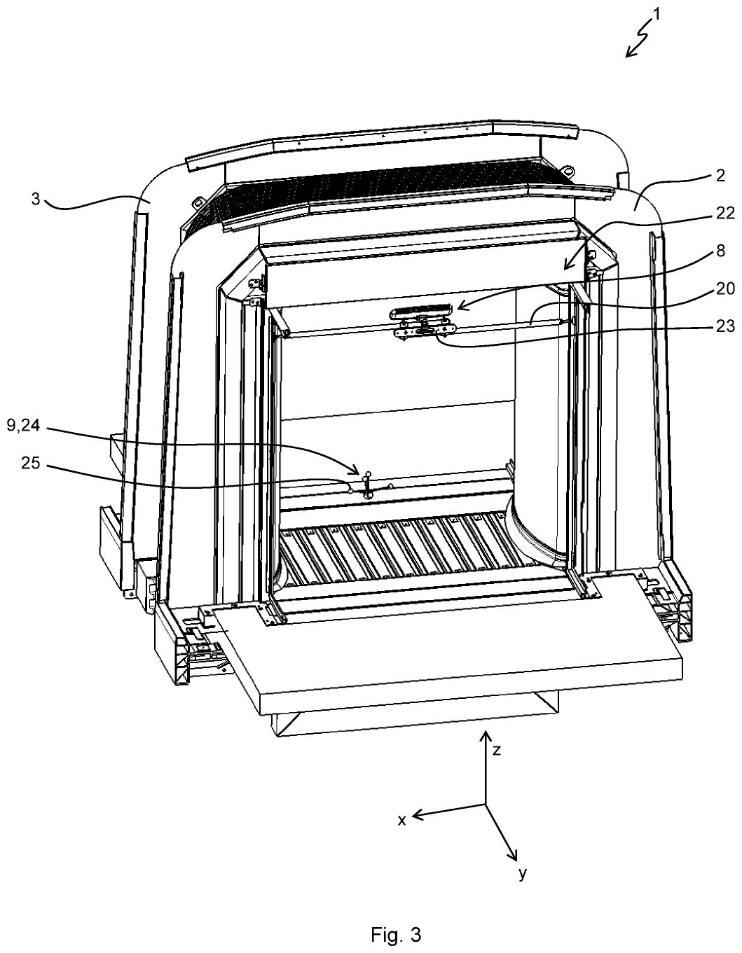

FIG. 3 shows a further possible embodiment and arrangement of a tracking system 7 for determining relative movements between the two movably connected vehicle parts 2, 3. The tracking system 7 shown in FIG. 2 comprises two tracking modules 8, 9, the tracking module 8 being arranged in the ceiling area 22 of the vehicle part 8 and the tracking module 9 being mounted to the floor of the vehicle part 9. In contrast to the embodiment of the sensor device 12 according to FIG. 1 and FIG. 2, the sensor device of FIG. 3 is not designed as a mechanical, but as an optical sensor device. The use of an optical sensor device makes it possible to implement the tracking system 7 with especially small installation space requirements and/or low weight, so that such a tracking system 7 can be mounted especially well also in the ceiling or side wall areas of the gangway 1. In particular, in such an arrangement, the tracking system 7 does not, or only to a minimal extent, impede changeover between the two vehicle parts 2, 3, so that the tracking system 7 can also be used in normal vehicle operation.

In the embodiment shown in FIG. 3, the tracking module 8 comprises two optical sensors in the form of cameras arranged at a distance to one another on a mounting adapter 23 of the tracking module 8. The tracking module 9 mounted to the other vehicle part 3 comprises a reference object 24 with multiple markers 25. The reference object 24 is designed as a kind of coordinate system, the markers 25 being arranged at end sections of the different axes of the coordinate system. The two tracking modules 8, 9, are arranged and orientated in relation to each other in such a way that the two cameras of the tracking module 8 can determine the positions of the markers 25 at the tracking module 9. In particular, the two cameras record the reference object 24 from two different perspectives. Image processing of the pictures recorded by the respective cameras allows to infer the position and orientation of the cameras in relation to the reference object 24. A continuous or quasi-continuous recording of pictures ultimately allows to infer the relative movements between the two tracking modules 8, 9, and hence also between the vehicle parts 2, 3.

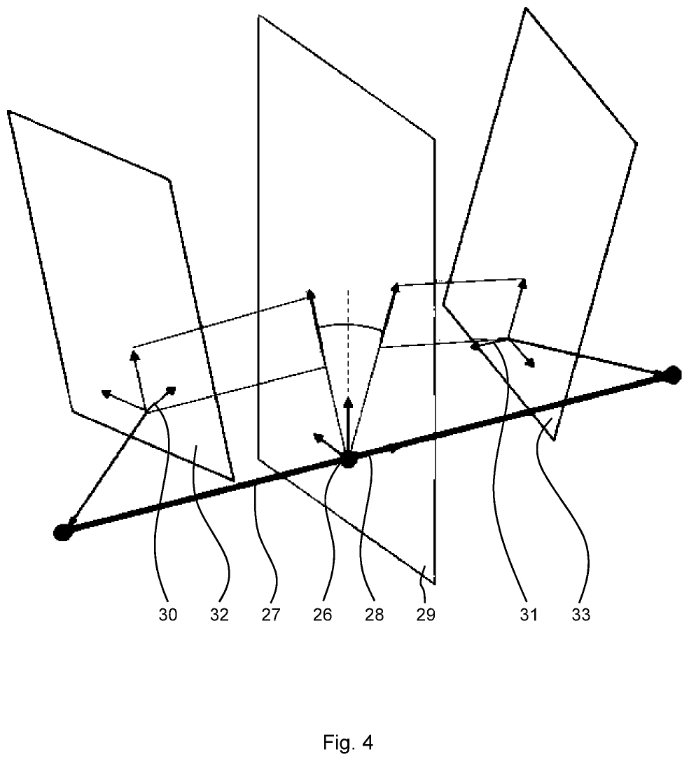

FIG. 4 shows a graphic model that visualizes the possible degrees of freedom between the vehicle parts relative to each other and in relation to a connection point 26 on a connecting line 27 between the two vehicle parts. The connecting line 27 can, e.g., be given by a coupling axle of a coupling that movably interconnects the two vehicle parts, the connection point 26 being the coupling point approximately midway between the two vehicle parts.

The connection point 26 is the point of origin of a coordinate system 28 with a plane 29 extending transverse to the connecting line 27. In addition to this, coordinate systems 30 and 31 can be defined which have their origin, e.g., at the location of the tracking system and which are spanned by the planes 32, 33, that are orientated perpendicular to connecting lines leading to the ends of the connecting line 27. These planes 32, 33 can, e.g., concur with the front walls of the vehicle parts.

As shown in FIG. 4, a relative position of the planes 32, 33, or of the front walls of the vehicle parts can be specified in relation to the center plane 29. To do this, the respective orientation of the coordinate axes of the coordinate systems 30, 31, can be projected to the plane 29 or be specified in relation to the coordinate system 29.

1. A tracking system for determining relative movements of a first vehicle part of a set of vehicles relative to a second vehicle part of the set of vehicles that is movably connected to the first vehicle part, the tracking system comprising:
a first tracking module associated with the first vehicle part,
a second tracking module associated with the second vehicle part, and
a sensor device for determining position and/or orientation of the first tracking module and the second tracking module relative to each other.

2. The tracking system according to claim 1, wherein:
the sensor device comprises at least one draw-wire linear transducer to acquire distance data between a first linkage point at the first tracking module and a second linkage point at the second tracking module.

3. The tracking system according to claim 1, wherein:
the first tracking module and the second tracking module each comprises three linkage points, and the sensor device comprises a draw-wire linear transducer provided at each of the linkage points of the first tracking module and the second tracking module, each of the draw-wire linear transducers being assigned to
one of the linkage points at the first tracking module which is also assigned to a different one of the draw-wire linear transducers; and
one of the linkage points at the second tracking module (9) which is assigned to another one of the draw-wire linear transducers other than the different one of the draw-wire linear transducers.

4. The tracking system according to claim 1, wherein:
the sensor device comprises at least one optical sensor that is arranged at the first or the second tracking module and operable to determine a distance to a reference object located at the other of the first or second tracking module, a position of the reference object, and/or an orientation of the reference object.

5. The tracking system according to claim 4, wherein the optical sensor comprises a camera that records pictures of the reference object.

6. The tracking system according to claim 1, wherein:
the sensor device comprises at least one optical sensor that is arranged at the first or the second tracking module and operable to determine a distance to a reference object located at the other of the first or second tracking module, a position of the reference object, and/or an orientation of the reference object, wherein the reference object comprises a self-luminous or reflective marker.

7. The tracking system according to claim 5, wherein:
at least two optical sensors are arranged at the first tracking module and/or the second tracking module each of the at least two optical sensors being operable to determine distance data between itself and the reference object and/or operable to determine a position and/or orientation of the reference object at the other of the first tracking module or the second tracking module.

8. The tracking system according to claim 6, wherein:
at least two optical sensors are arranged at the first tracking module and/or the second tracking module each of the at least two optical sensors being operable to determine distance data between itself and the reference object and/or operable to determine a position and/or orientation of the reference object at the other of the first tracking module or the second tracking module.

9. The tracking system according to claim 1, wherein the sensor device further comprises, at each of the first tracking module and the second tracking module, one or more sensors selected from the group consisting of: an acceleration sensor, an angular rate sensor, a magnetic field sensor, and a GNSS sensor.

10. The tracking system according to claim 8, wherein the one or more sensors comprises the acceleration sensor, the angular rate sensor and/or the magnetic field sensor, as well as the GNSS sensor, wherein the tracking system further comprises:
a calibration unit for automatic calibration of the acceleration sensor, the angular rate sensor, and/or the magnetic field sensor at regular or irregular intervals, the calibration unit comprising an input interface for receiving data of the GNSS sensor and/or of an external reference signal, so that the data from the GNSS sensor and/or the external reference signal are utilizable to calibrate the acceleration sensor, the angular rate sensor, and/or the magnetic field sensor.

11. The tracking system according to claim 1, further comprising
an evaluation device utilizable to classify relative movements between the first vehicle part and the second vehicle part.

12. The tracking system according to claim 11, wherein the evaluation device is operable to acquire data about a route profile that the set of vehicles is traveling, based on the relative movements.

13. A method for determining, via a tracking system, relative movements of a first vehicle part of a set of vehicles in relation to a second vehicle part of the set of vehicles that is movably connected to the first vehicle part, the method comprising:
arranging a first tracking module of the tracking system at the first vehicle part;
arranging a second tracking module of the tracking system at the second vehicle part; and
determining a position and/or an orientation of the first tracking module and the second tracking module relative to each other via a sensor device of the tracking system.

14. The method according to claim 13, wherein:
at least one distance data between a first linkage point at the first tracking module and a second linkage point at the second tracking module is acquired via a draw-wire linear transducer to determine the position and/or the orientation of the first tracking module and the second tracking module relative to each other.

15. The method according to claim 14, further comprising:
acquiring additional distance data between a further linkage point at the first tracking module and a further linkage point at the second tracking module via a further draw-wire linear transducer.

16. The method according to claim 13, wherein:
at least one reference object arranged at the first tracking module is recorded via at least one optical sensor arranged at the second tracking module to determine the position and/or the orientation of the first tracking module and the second tracking module relative to each other, wherein the position and/or the orientation of the first tracking module and the second tracking module relative to each other is determined based on data recorded by the at least one optical sensor.

17. The method according to claim 13, wherein:
relative movements between the first tracking module and the second tracking module are classified in accordance with predefined standard movements and/or data about a route profile that the set of vehicles is traveling is acquired based on relative movements between the first tracking module and the second tracking module.

18. A tracking system for a set of vehicles having a first vehicle part and a second vehicle part that is movably connected to the first vehicle part, the tracking system determines relative movements of the first vehicle part relative to the second vehicle part and comprises:
a first tracking module connected to the first vehicle part;
a second tracking module connected to the second vehicle part; and
a sensor device operable to determine a position and/or an orientation of the first tracking module and the second tracking module relative to each other.
